(19) United States
(12) Patent Application Publication
(10) Pub. No.: US 2026/0195610 A1
(43) Pub. Date: Jul. 9, 2026

(54) SYSTEMS AND METHODS FOR USING DECISION TREES FOR ARTIFICIAL INTELLIGENCE MODELS OPERATING ON NONTABULAR OR SEQUENTIAL DATA THAT REQUIRE INTERPRETABILITY

(71) Applicant: Capital One Services, LLC, McLean, VA (US)

(72) Inventors: Samuel SHARPE, Somerville, MA (US); Galen RAFFERTY, Mahomet, IL (US); Brian BARR, Schenectady, NY (US); Taylor TURNER, Richmond, VA (US)

(73) Assignee: Capital One Services, LLC, McLean, VA (US)

(21) Appl. No.: 19/014,210

(22) Filed: Jan. 8, 2025

(51) Int. Cl. G06N 5/01

(52) U.S. Cl. CPC G06N 5/01

(57) ABSTRACT

Systems and methods create decision trees from transformer weights for the non-tabular and sequential data. For example, the system may take initial non-tabular and/or sequential data convert it into a binary variable (e.g., is it there or not). The system may then extract features out of the model that is learned on the data as opposed to extracting features itself. The system may then fit a decision tree on these extracted features to generate an approximation of the transformer that is interpretable/explainable.

### BACKGROUND

An artificial intelligence model may be a framework or algorithm designed to perform specific tasks by learning from data. It may rely on several key components: data, algorithms, training, parameters, and inference. These models may be categorized into supervised learning models, which are trained on labeled data for tasks like regression and classification; unsupervised learning models, which are trained on unlabeled data to find patterns, such as clustering and dimensionality reduction; and reinforcement learning (RL) models, which learn by interacting with an environment and receiving feedback in the form of rewards or penalties. These models may have diverse applications, including natural language processing (NLP) for language translation, sentiment analysis, and chatbots; computer vision for image recognition, facial recognition, and autonomous driving; recommendation systems for suggesting products, movies, or content based on user preferences; and predictive analytics for forecasting trends, predicting stock prices, and detecting fraud.

Interpretability and/or explainability (referred to as simply “interpretability” for simplicity) is a significant challenge for artificial intelligence because it refers to the extent to which humans can understand and trust the decisions and outputs generated by the models. Many models, particularly complex ones like deep neural networks, operate as “black boxes,” where the internal workings are not transparent or easily understood by humans. This lack of transparency makes it difficult to diagnose errors, ensure fairness, and build trust in these systems. When a model makes a decision, especially in high-stakes areas such as healthcare, finance, or criminal justice, it is crucial to understand the rationale behind that decision. Without interpretability, it becomes challenging to verify that the model is functioning correctly and ethically, to identify and correct biases, and to provide explanations to stakeholders. Moreover, regulatory and legal frameworks often require transparency in decision-making processes, which is hindered by opaque models. Thus, the problem of interpretability in these models not only limits the adoption of these technologies but also raises ethical and practical concerns about their deployment in real-world applications.

### SUMMARY

Systems and methods are described herein for novel uses and/or improvements to artificial intelligence applications, particularly in terms of interpretability of the artificial intelligence applications and/or the predictions provided by those application. As one example, systems and methods are described herein for increased interpretability in network routing decisions despite the network data being non-tabular and/or sequential. For example, non-tabular data may refer to data that does not fit neatly into the rows and columns of a traditional table structure, such as those found in relational databases or spreadsheets. Unlike tabular data, which is organized into a structured format with a fixed schema, non-tabular data is often unstructured or semi-structured, making it more complex to analyze and process. Likewise, sequential data refers to a type of data where the order of the elements is significant and carries meaningful information. Unlike independent and identically distributed data points found in tabular data, sequential data is characterized by dependencies and relationships between consecutive elements. To increase interpretability of a model despite the model using non-tabular and/or sequential data, the systems and methods uses decision tree models.

Decision tree models offer increased interpretability due to their straightforward and intuitive structure. For example, these models can be easily visualized as tree-like diagrams, where each node represents a decision based on a feature, and each branch signifies the outcome of that decision. This visual format is intuitive and easy for humans to understand. The entire process is transparent, allowing one to trace the path from the root to a leaf node to see how a particular decision or prediction was made. This transparency clarifies how input features are utilized to reach a conclusion. Furthermore, decision trees inherently highlight which features are most important for making decisions. Features appearing higher in the tree, closer to the root, are generally more significant in predicting the outcome, providing insights into the relative importance of different features. Additionally, decision trees do not require feature scaling, using raw feature values directly, which contributes to the model's interpretability since the values are easily recognizable and meaningful in their original form.

Unfortunately, it is impossible to use decision trees on non-tabular data because decision trees are inherently designed to handle structured data organized in a tabular format, where each row represents a data instance and each column represents a feature or attribute. For instance, in the case of text data, which is inherently unstructured, a decision tree cannot parse and utilize the raw text for decision-making. Similarly, for image data, decision trees cannot interpret the pixel values as meaningful features. Audio and video data pose similar challenges, as they are continuous and multidimensional. The essence of non-tabular data is its complexity and the rich, unstructured information it contains, which decision trees are not equipped to handle due to their design for structured, tabular data.

Similarly, sequential data, such as time series, text, audio, and video, inherently involve dependencies between consecutive elements or events. These dependencies carry crucial contextual information that decision trees are not inherently equipped to capture. For example, in time series data, the value at any given time point is often dependent on the values at previous time points. Decision trees, however, treat each instance separately and do not account for the order or temporal dependencies between data points.

To overcome these technical deficiencies in using decision trees for artificial intelligence models operate on non-tabular and sequential data that require interpretability, the systems and methods disclosed herein create decision trees from transformer weights for the non-tabular and sequential data. For example, the system may take initial non-tabular and/or sequential data convert it into a binary variable (e.g., is it there or not). The system may then extract features out of the model that is learned on the data as opposed to extracting features itself. The system may then fit a decision tree on these extracted features to generate an approximation of the transformer that is interpretable/explainable.

In some aspects, systems and methods are described for using decision trees for artificial intelligence models operating on non-tabular or sequential data that require interpretability. For example, the system may receive user profile data of a user interacting with a first computer terminal. The system may input the user profile data into a decision tree, wherein the decision tree is generated by: retrieving a first artificial intelligence model, wherein the first artificial intelligence model is a transformer model for determining recommendations, wherein the transformer model is trained on a first training data set to generate sequential aware features, and wherein the first training data set comprises sequential time-series data that is generated based on monitoring data processing requests across a plurality of computer networks; determining a first sequential aware feature for the first artificial intelligence model; converting the first sequential aware feature into a binary variable feature; and fitting a decision tree to the binary variable feature. The system may receive a first output from the decision tree. The system may generate for display, on a user interface, a first recommendation based on the first output, wherein the first recommendation indicates an interaction outcome of the user and the first computer terminal.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram for generating explanations for network routing predictions, in accordance with one or more embodiments.

FIG. 1B shows an illustrative user interface for generating explanations for predictions used to determine dynamic conversational responses, in accordance with one or more embodiments.

FIG. 2A shows an illustrative diagram for generating explanations related to cyber security predictions, in accordance with one or more embodiments.

FIG. 2B shows an illustrative diagram for generating explanations related to generated recommendations, in accordance with one or more embodiments.

FIG. 3 shows illustrative components for a system used to facilitate artificial intelligence models operating on non-tabular or sequential data that require interpretability, in accordance with one or more embodiments.

FIG. 4 shows a flowchart of the steps involved in artificial intelligence models operating on non-tabular or sequential data that require interpretability, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

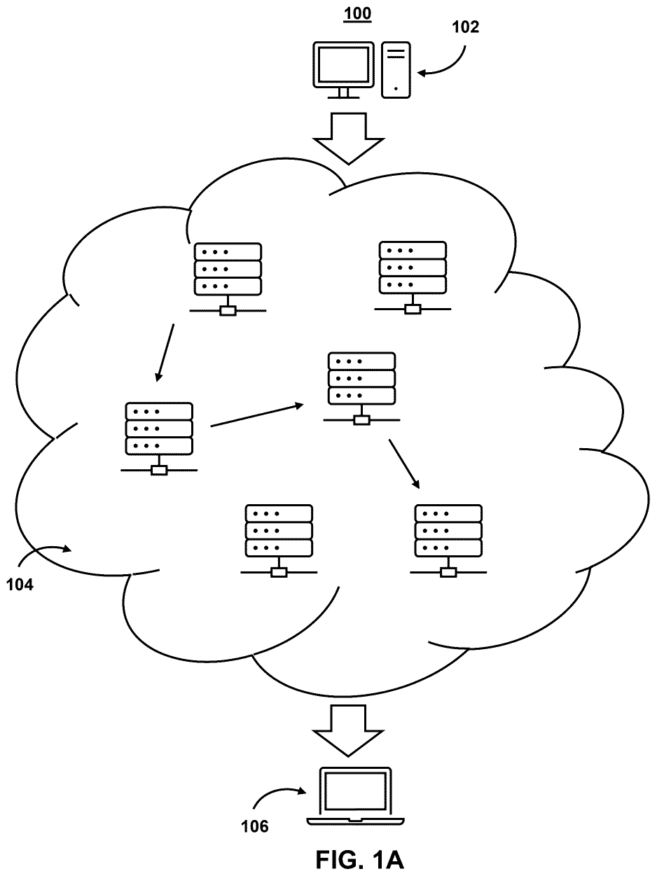

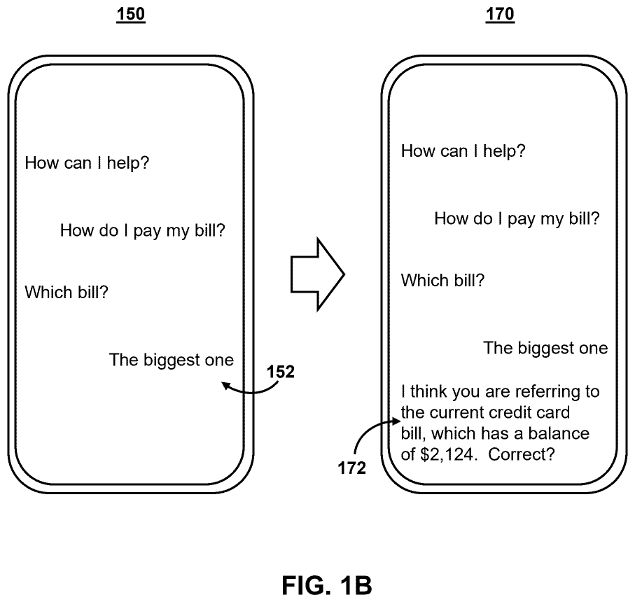

FIG. 1A shows an illustrative diagram for generating explanations for network routing predictions, in accordance with one or more embodiments. FIG. 1A shows system 100 that may be used to determine network routing for data from device 102 to device 106 across network 104. Device 102 and/or device 106 may include any computing component. In some instances, device 102 may include a user interface. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

In some embodiments, the content may include sequential or non-tabular data (e.g., time-series data). As described herein, “time-series data” may include a sequence of data points that occur in successive order over some period of time. In some embodiments, time-series data may be contrasted with cross-sectional data, which captures a point-in-time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time series analysis. For example, a time series analysis may be useful to see how a given asset, security, or economic variable changes over time. It can also be used to examine how the changes associated with the chosen data point compare to shifts in other variables over the same time period. For example, with regards to retail loss, the system may receive time series data for the various sub-segments indicating daily values for theft, product returns, etc.

The time-series analysis may determine various trends such as a secular trend, which describe the movement along the term, a seasonal variation, which represent seasonal changes, cyclical fluctuations, which correspond to periodical but not seasonal variations, and irregular variations, which are other nonrandom sources of variations of series. The system may maintain correlations for this data during modeling. In particular, the system may maintain correlations through non-normalization as normalizing data inherently changes the underlying data which may render correlations, if any, undetectable and/or lead to the detect of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of anon-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias tests are robust for detecting irregular distributions, while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays such as Easter and Chinese New Year fall in different periods in each year, hence they will distort observations. Also, year-to-year values will be biased by any changes in seasonal patterns that occur over time. For example, consider a comparison between two consecutive March months (i.e., compare the level of the original series observed in March for 2000 and 2001). This comparison ignores the moving holiday effect of Easter. Easter occurs in April for most years but if Easter falls in March, the level of activity can vary greatly for that month for some series. This distorts the original estimates. A comparison of these two months will not reflect the underlying pattern of the data. The comparison also ignores trading day effects. If the two consecutive months of March have different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may in some cases be normalized to account for this issue, the normalization of one data stream segment (e.g., for one component model) may affect another data stream segment (e.g., for another component model). Individual normalizations may distort the relationship and correlations between the data leading to issues and negative performance of a composite data model.

As referred to herein, a “modeling error” or simply an “error” may correspond to an error in the performance of the model. For example, an error in a model may comprise an inaccurate or imprecise output or prediction for the model. This inaccuracy or imprecision may manifest as a false positive or a lack of detection of a certain event. These errors may occur in models corresponding to a particular sub-segment (e.g., a component model as described herein) that result in inaccuracies for predictions and/or output based on the sub-segment, and/or the errors may occur in models corresponding to an aggregation of multiple sub-segments (e.g., a composite model as described herein) that result in inaccuracies for predictions and/or outputs based on errors received in one or more of predictions of the plurality of sub-segments and/or an interpretation of the predictions of the plurality of sub-segments.

Network 104 may include several essential components that work together to facilitate communication and resource sharing among devices. The primary components include network devices such as routers, switches, and hubs, which manage and direct the flow of data across the network. Routers are responsible for forwarding data packets between different networks, ensuring that information reaches its correct destination. Switches connect multiple devices within the same network, allowing them to communicate efficiently by directing data to the appropriate device. Hubs, although less common today, also connect multiple devices but broadcast data to all connected devices, leading to less efficient communication. Additionally, network 104 may include end devices such as computers, servers, printers, and other peripherals that use the network to access and share resources. These devices are connected via network interfaces, which can be wired (using Ethernet cables) or wireless (using Wi-Fi). Network interfaces enable devices to communicate with each other and access the network infrastructure.

Communication protocols, such as TCP/IP (Transmission Control Protocol/Internet Protocol), may be used by network 104 to define the rules and standards for data transmission. These protocols ensure that data is formatted, transmitted, received, and processed correctly, enabling seamless communication between different devices and networks. Network media, including cables (such as fiber optic, coaxial, and twisted pair) and wireless signals, provide the physical means through which data travels. The choice of media impacts the speed, distance, and reliability of data transmission within network 104. Network services, such as DNS (Domain Name System) and DHCP (Dynamic Host Configuration Protocol), support the network's functionality by translating domain names into IP addresses and dynamically assigning IP addresses to devices, respectively. These services ensure that devices can easily locate and communicate with each other on network 104.

System 100 may use a model to make network routing predictions that optimize characteristics such as bandwidth, throughput, power consumption, processing speed, reliability, and other performance metrics by leveraging different machine learning training regimes, including supervised learning, unsupervised learning, and (RL).

System 100 may use different training regimes depending on the specific goals and available data. In supervised learning, the model is trained on labeled data, where each training example includes both the input network conditions and the desired optimal routing decisions. Historical network data, such as traffic patterns, node performance, and past routing decisions, serve as the primary source of training data. This data is labeled with performance metrics indicating the effectiveness of different routing strategies. The AI model learns to map network conditions to optimal routing paths by minimizing the error between its predictions and the actual outcomes observed in the training data. Supervised learning is particularly effective when there is a rich dataset of historical performance metrics available.

Unsupervised learning does not rely on labeled data. Instead, it aims to uncover hidden patterns and relationships within the network data. For network routing, unsupervised learning can cluster network states or detect anomalies in traffic patterns. For instance, clustering algorithms can group similar network conditions, helping to identify typical routing scenarios and their associated performance characteristics. This information can inform routing decisions by highlighting common traffic behaviors and potential bottlenecks. Training data for unsupervised learning is usually generated from historical network logs, capturing a wide array of network conditions and traffic patterns without specific labels.

RL is particularly suited for dynamic and complex environments like network routing. In RL, an agent learns by interacting with the network environment, making routing decisions, and receiving feedback through rewards or penalties based on the resulting performance metrics. The agent aims to maximize cumulative rewards by learning optimal routing policies over time. Training data for RL is generated through simulations or real-time interactions, where the agent explores various routing strategies and observes their impact on network performance. Simulations can be used to create diverse scenarios, including rare or extreme conditions, ensuring the model can handle a wide range of network states.

For supervised learning, training data is generated from historical network logs, where past routing decisions and their outcomes provide a labeled dataset. In unsupervised learning, the same historical logs are used, but the focus is on identifying patterns and clusters within the data rather than specific labels. For RL, training data is often generated through a combination of real-time network interactions and simulated environments. Simulations allow the RL agent to experience a broad spectrum of network conditions, facilitating robust learning without the risk of disrupting live network operations.

By combining these training regimes, the model can develop a comprehensive understanding of the network and optimize routing decisions to enhance overall performance. Supervised learning provides precise mapping from conditions to decisions, unsupervised learning uncovers underlying patterns, and RL adapts dynamically to real-time changes, ensuring the network operates efficiently and reliably.

FIG. 1B shows an illustrative user interface for generating explanations for predictions used to determine dynamic conversational responses, in accordance with one or more embodiments. For example, user interface 150 may receive one or more user queries (e.g., user query 152) and generate a dynamic conversational response (e.g., response 172) as shown in user interface 170.

As described herein, a user query may be a request for information or an action made by a user to a system, typically through a search engine, database, or any interactive application like a chatbot. The query represents the user's specific need or question and can be expressed in various forms, such as a keyword search, a natural language question, or a command. In the context of search engines, a user query might be a set of keywords or a phrase entered into the search bar to find relevant information. For instance, a user might type “best Italian restaurants in New York” to get a list of recommendations. In databases, a user query often takes the form of a structured query language (SQL) statement designed to retrieve specific data from a database. For example, a query might be “SELECT*FROM employees WHERE department=‘Sales’”. In interactive applications like chatbots, a user query could be a conversational prompt or question, such as “What is the weather today?” or “Can you help me book a flight to London?”. The chatbot processes this input to provide an appropriate response or perform the requested action.

As described herein, a dynamic conversational response may be an adaptive and contextually relevant reply generated by a system, such as a chatbot or virtual assistant, in real-time based on the specific input provided by the user. Unlike static responses, which are pre-scripted and limited to specific prompts, dynamic responses may be generated on-the-fly and can handle a wide variety of user inputs with flexibility and coherence. For example, if a user asks a chatbot, “Can you recommend a good restaurant nearby?”, a dynamic conversational response may consider the user's location, preferences, and possibly previous interactions to suggest a specific restaurant with a personalized recommendation. If the user follows up with “What type of cuisine do they offer?”, the chatbot would maintain context and provide relevant information about the restaurant's menu.

For example, as shown in FIG. 1B, the system may determine a context of a user query (e.g., query 152) to determine a personalized response (e.g., response 172). In some embodiments, the system may use user profile information to generate response 172 (e.g., user profile information that indicates an account balance). The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

The system may use a model to generate dynamic conversational responses in a chatbot application by employing natural language processing (NLP) techniques and machine learning algorithms. The model, typically a neural network-based architecture like a transformer model (e.g., GPT-4), may be designed to understand and generate human-like text based on the context of the conversation. The model may process the input from the user, identifies the intent, and formulates a coherent and contextually appropriate response. This process involves several stages, including tokenization (breaking down the text into smaller units), understanding the semantic meaning, and generating a relevant response that maintains the flow of the conversation.

Training the model for such applications can be done using various regimes, including supervised learning, unsupervised learning, and RL (as discussed above). In supervised learning, the model is trained on a large corpus of labeled conversational data, where each input is paired with a desired response. This data often comes from transcripts of real conversations, chat logs, or specially curated datasets that cover a wide range of conversational contexts. The model learns to predict the appropriate response based on the input text, gradually improving its accuracy by minimizing the difference between its predictions and the actual responses in the training data.

Unsupervised learning, on the other hand, does not rely on labeled data. Instead, it involves training the model on large amounts of text data without explicit input-response pairs. The model learns the structure and patterns of natural language through techniques like language modeling, where it predicts the next word or sequence of words in a sentence. This approach helps the model understand grammar, context, and common conversational patterns, making it more adept at generating plausible responses even in unfamiliar contexts.

RL can also be applied, where the model interacts with users in real-time and receives feedback on the quality of its responses. The feedback serves as a reward or penalty, guiding the model to refine its conversational strategies. For instance, positive feedback (such as user satisfaction or engagement metrics) encourages the model to generate similar responses in the future, while negative feedback helps it avoid unproductive or inappropriate responses. This approach enables the model to adapt and improve continuously based on actual user interactions.

To generate training data under these different regimes, a combination of real conversational data, simulated interactions, and data augmentation techniques is often used. Real conversational data provides authentic examples of human dialogue, while simulated interactions can create diverse scenarios to expose the model to various conversational contexts. Data augmentation techniques, such as paraphrasing and introducing linguistic variations, further enrich the training dataset, ensuring the model learns to handle a wide range of inputs. By integrating these training regimes, the AI model develops a robust understanding of natural language, enabling it to generate dynamic and contextually appropriate conversational responses in chatbot applications. This adaptability ensures that the chatbot can engage users effectively, providing relevant and meaningful interactions across diverse conversational scenarios.

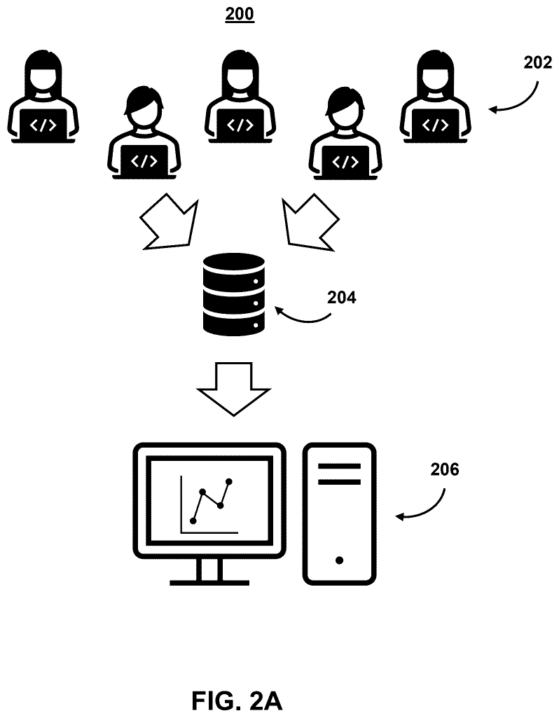

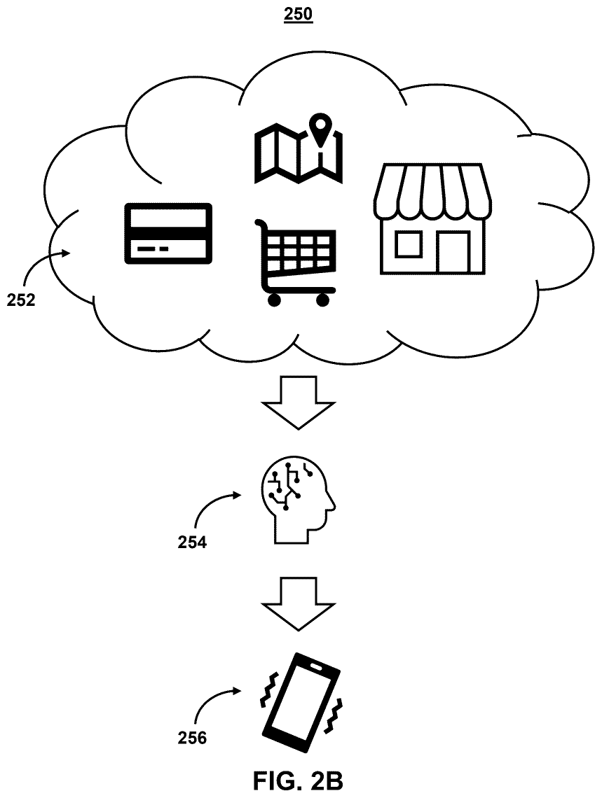

FIG. 2A shows an illustrative diagram for generating explanations related to cyber security predictions, in accordance with one or more embodiments. For example, as shown in FIG. 2A, system 200 may detect one or more cyber security incidents based on actions by one or more users (e.g., users 202).

In some examples, cybersecurity incidents that may be detected using a model may include a wide range of malicious activities and anomalies. These can encompass phishing attacks, where the model can identify suspicious emails that attempt to deceive employees into divulging sensitive information. The model may also detect malware by recognizing unusual patterns of behavior or code within software applications. Additionally, the model may identify brute force attacks by spotting numerous failed login attempts within a short timeframe. Advanced persistent threats (APTs), which involve prolonged and targeted cyber attacks, can also be detected by the model by monitoring for subtle and persistent anomalies in network traffic and system behavior. For example, a model may receive user activity (e.g., at server 204) and may analyze the data for anomalies in network traffic and system behavior.

The model may analyze large volumes of data in real-time makes it particularly effective at identifying these and other threats, such as data breaches, insider threats, and distributed denial-of-service (DDoS) attacks, by recognizing patterns that deviate from the norm. In some embodiments, the system may detect cyber security incidents at financial services companies. One common threat is fraud, where attackers use stolen credentials or synthetic identities to make unauthorized transactions or access sensitive financial information. Phishing schemes are also prevalent, targeting both employees and customers to steal personal information or distribute malware. Additionally, ransomware attacks pose a significant risk, where malicious software encrypts company data, demanding a ransom for its release. Financial institutions are also vulnerable to sophisticated attacks such as APTs, where cybercriminals infiltrate the network and remain undetected for extended periods, extracting valuable data. Insider threats, whether from malicious intent or accidental negligence, can also lead to significant security breaches. Furthermore, DDoS attacks can disrupt services by overwhelming the company's servers with traffic, leading to downtime and potential financial loss. AI models help mitigate these risks by continuously monitoring for unusual activities, analyzing vast amounts of data for threats, and providing early warnings of potential security incidents, thereby enhancing the company's overall security posture. By analyzing patterns in user activity, the system may generate one or more recommendations that may be shown on user device 206.

FIG. 2B shows an illustrative diagram for generating explanations related to generated recommendations, in accordance with one or more embodiments. For example, system 250 may generate recommendations based on user activity using model 254 to generate recommendation on a user device (e.g., device 256).

System 250 may generate recommendations by utilizing algorithms and data analysis techniques to suggest items, services, or content that align with the user's preferences and behavior. The process typically begins with data collection, where the system gathers information on user interactions (e.g., data 252), such as browsing history, purchase history, location, merchant information, ratings, and/or demographic data. This data is then processed and analyzed using various recommendation algorithms, which can be broadly categorized into collaborative filtering, content-based filtering, and hybrid methods.

System 250 may use collaborative filtering to determine users who have shown similar behavior in the past may have similar preferences in the future. It identifies patterns and similarities between users and items to make recommendations. For instance, if user A and user B have both liked similar books, and user A reads a new book, the system might recommend this book to user B.

System 250 may use content-based filtering to determine the attributes of items and users'past preferences. System 250 may recommend items that are similar to those the user has shown interest in before. For example, if a user frequently watches sci-fi movies, the system will recommend new sci-fi movies by analyzing the characteristics of previously liked movies.

System 250 may use hybrid methods that combine both collaborative and content-based approaches to leverage the strengths of each. For example, system 250 may adjust recommendations based on a wider range of data and offer more accurate suggestions. The recommendations are then presented to the user through the interface, often prioritized or personalized based on the most relevant or popular items. The system continuously updates its models with new data to improve the accuracy and relevance of future recommendations, ensuring that the suggestions evolve with the user's changing preferences and behaviors.

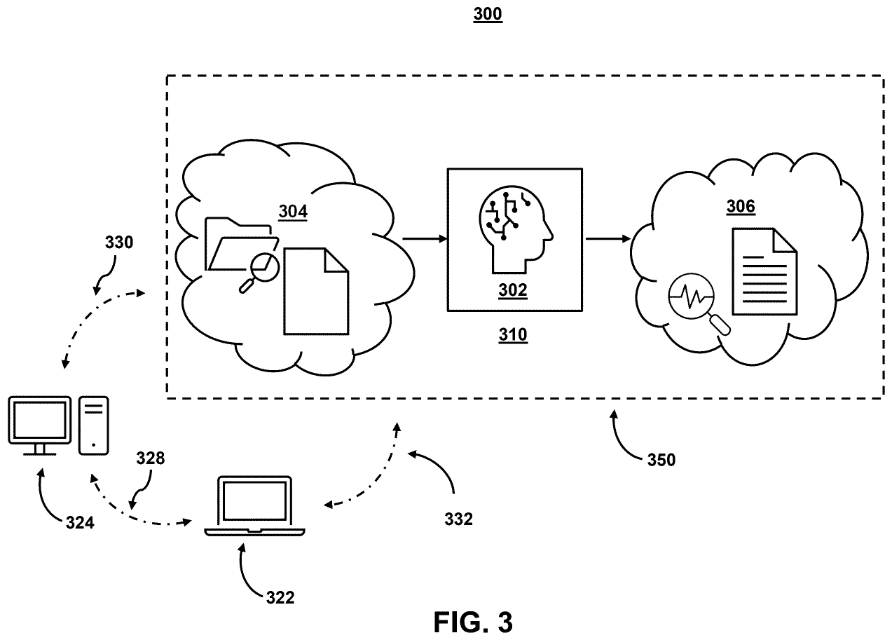

FIG. 3 shows illustrative components for a system used to facilitate artificial intelligence models operating on non-tabular or sequential data that require interpretability, in accordance with one or more embodiments. For example, FIG. 3 may show illustrative components for generating explanations for network routing predictions, generating user recommendations, and/ort generating credit application decisions. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a sequence identifier, an attention value, a recommendation, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output (e.g., a sequence identifier, an attention value, a recommendation, etc.).

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to generate one or more decision trees.

In some embodiments, model 302 may comprise a decision tree. For example, a decision tree is a machine learning model used for classification and regression tasks, designed to make decisions based on the features of the input data. In such cases, model 302 may recursively split the data into subsets based on the values of input features, forming a tree-like structure where each internal node represents a decision point on a feature, each branch represents the outcome of the decision, and each leaf node represents a final decision or prediction. The process begins at the root node, where the data is split based on the feature that provides the best separation according to a chosen metric, such as Gini impurity for classification or mean squared error for regression.

The components of a decision tree may include nodes, branches, and leaves. The root node is the topmost node of the tree, where the first decision is made. Internal nodes, also known as decision nodes, represent subsequent decisions based on different features. Each decision node splits the data into two or more branches, which represent the possible outcomes of the decision at that node. These branches lead to either more decision nodes or to leaf nodes. Leaf nodes, also known as terminal nodes, represent the final output or class label for classification tasks or the predicted value for regression tasks.

To determine the best feature for splitting the data at each node, decision trees use criteria such as Gini impurity, information gain, or variance reduction. Gini impurity and information gain are commonly used for classification tasks, measuring the homogeneity of the subsets. A feature that results in the most homogeneous subsets is chosen for the split. For regression tasks, variance reduction measures how much the variance within the subsets is decreased after the split, aiming to find splits that lead to more precise predictions.

The decision tree algorithm continues to split the data until a stopping criterion is met, such as a maximum tree depth, a minimum number of samples per leaf, or no further improvement in the splits. This recursive partitioning process results in a model that is easy to understand and interpret, as each path from the root to a leaf represents a series of logical decisions leading to a final prediction.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

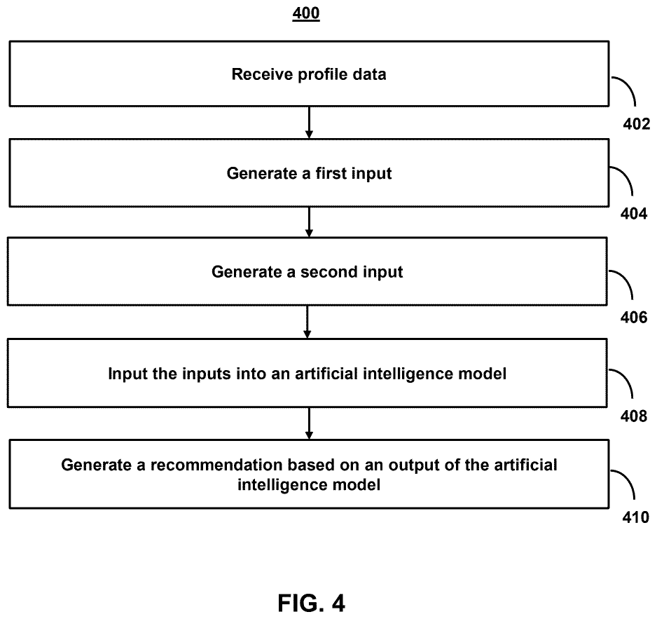

FIG. 4 shows a flowchart of the steps involved in artificial intelligence models operating on non-tabular or sequential data that require interpretability, in accordance with one or more embodiments. For example, the system may use process 400 (e.g., as implemented on one or more system components described above) in order to determine interpretable network routing decisions using decision trees for artificial intelligence models operating on non-tabular or sequential network data.

At step 402, process 400 (e.g., using one or more components described above) receives user profile data. For example, the system may receive user profile data of a user interacting with a first computer terminal. The system receives user profile data, network profile data, and/or other profile data of a user interacting with a first computer terminal or data processing request across a computer network through various mechanisms designed to capture and transmit relevant information.

For example, when a user interacts with a computer terminal, such as logging into a service, browsing a website, or using an application, the system collects profile data, which can include personal information, preferences, usage patterns, and behavior. This data is typically gathered through forms, cookies, tracking scripts, and user input, and is stored in databases associated with the service or application. In addition to user profile data, network profile data is collected to understand the context of the user's interactions. This includes information about the user's device, IP address, network conditions, geolocation, and other metadata related to the network connection. When a user initiates a data processing request, such as submitting a query, downloading a file, or accessing cloud services, the system captures this network profile data through network monitoring tools, logging mechanisms, and API interactions. The collected data is transmitted over the network to a central server or a cloud-based system where it is processed and analyzed. Secure transmission protocols, such as HTTPS, are often used to ensure the privacy and security of the data during transit. Once the data reaches the server, it is typically aggregated, stored in a structured format, and analyzed using various data processing techniques. This analysis can include machine learning algorithms, statistical methods, and pattern recognition techniques to derive insights, personalize user experiences, optimize network performance, and enhance security measures.

At step 404, process 400 (e.g., using one or more components described above) inputs the user profile data into a decision tree. For example, the system may determine current network profile data for the first computer network, user profile data for an interaction with a user, etc. In some embodiments, the system may generate the decision tree using sequential aware features (e.g., feature that preserve a sequence in data).

For example, the system may retrieve a first artificial intelligence model, wherein the first artificial intelligence model is a transformer model for determining recommendations, wherein the transformer model is trained on a first training data set to generate sequential aware features, and wherein the first training data set comprises sequential time-series data that is generated based on monitoring data processing requests across a plurality of computer networks. The transformer model is trained on a first training data set specifically composed of sequential time-series data. The time-series data is generated by monitoring data processing requests across a plurality of computer networks. During training, the model learns to capture complex dependencies and patterns within the sequential data, enabling it to understand the temporal context and relationships between different data points. Transformers, known for their effectiveness in handling sequences, utilize mechanisms like self-attention to weigh the significance of each element in the sequence relative to others. This ability to focus on different parts of the input sequence allows the model to generate features that are sensitive to the order and timing of events, which is crucial for making accurate and relevant recommendations.

The first training data set, may comprise extensive time-series data, reflects the behavior and interactions within the monitored computer networks. This data includes details such as the sequence of data processing requests, timestamps, network conditions, user interactions, and other relevant metrics. By training on this rich dataset, the transformer model develops a nuanced understanding of how data processing requests evolve over time and how different network factors influence these requests. As a result, the transformer model can generate sequentially aware features that enhance its recommendation capabilities. These features help the model make informed decisions, predicting future requests and optimizing network resources effectively. This approach ensures that the recommendations are not only based on static data points but also consider the dynamic and temporal nature of the interactions within the network, leading to more accurate and contextually relevant outcomes.

The system may determine a first sequential aware feature for the first artificial intelligence model. For example, a sequentially aware feature for the first artificial intelligence model may refer to a type of feature that captures and reflects the temporal dependencies and order of data points within a sequence. Unlike static features, which treat each data point independently, sequentially aware features recognize the importance of the order in which events occur and the relationships between them over time. For example, in a network monitoring scenario, a sequentially aware feature might capture trends such as the frequency of data processing requests during specific times of the day, the duration between consecutive requests, or the evolving network load patterns. These features could also include the identification of recurring sequences of events that precede network bottlenecks or security incidents. By embedding this temporal context into the model's feature set, the transformer can better predict future network behavior and make more accurate recommendations. The process of generating sequentially aware features involves using the transformer model's self-attention mechanism to analyze the entire sequence of data points. The model learns to assign different weights to various parts of the sequence, effectively highlighting the most relevant information needed to make predictions or recommendations. This allows the model to focus on important patterns, such as spikes in network traffic following specific events or the gradual build-up of requests leading to a peak period.

For example, if the sequentially aware feature is the frequency of data processing requests and the threshold is set at 100 requests per minute, and the system observes 120 requests in a given minute, the binary variable feature would be set to 1. If the system observes 80 requests in another minute, the binary variable feature would be set to 0. This binary conversion simplifies the feature, making it easier to use in subsequent analyses or modeling processes, particularly for classification tasks where the goal is to predict the occurrence of a specific event or condition. By converting a complex sequentially aware feature into a binary variable, the system can effectively incorporate temporal patterns into a simpler and more interpretable format, facilitating more straightforward decision-making processes.

In some embodiments, the system may determine the first sequential aware feature for the first artificial intelligence model by determining an attention value for first artificial intelligence model and populating an attention matrix for the first artificial intelligence model with the attention value. For example, determining attention values during model training, particularly in neural networks like transformers, involves a series of computations to capture the importance of each element in a sequence relative to others. Initially, input data is represented as vectors using embedding techniques. For each input vector, three new vectors are derived using learned weight matrices: the query (Q) vector, which represents the element for which attention scores are being computed; the key (K) vector, which represents the elements that the query is attending to; and the value (V) vector, which represents the elements that contribute to the final output based on the attention scores.

The attention score between two elements is computed as the dot product of their query and key vectors. To prevent these scores from becoming too large, they are scaled by the square root of the dimension of the key vectors. These scaled scores are then passed through a softmax function to convert them into probabilities (attention weights) that sum to 1, helping to focus on the most relevant parts of the input sequence. The attention weights are used to compute a weighted sum of the value vectors, producing the final output for each element.

In some embodiments, multiple sets of query, key, and value vectors (heads) are often used to capture different aspects of the relationships within the data. Each head performs the attention mechanism independently, and their outputs are concatenated and linearly transformed to produce the final result. During model training, the parameters involved in the attention mechanism (the weight matrices used to compute Q, K, and V) are updated through backpropagation. The gradients of the loss function with respect to these parameters are computed, and optimization algorithms like gradient descent are used to minimize the loss, thereby refining the attention values. This process enables the model to learn to focus on different parts of the input sequence, capturing complex dependencies and improving its ability to make accurate predictions or generate coherent responses.

The system may convert the first sequential aware feature into a binary variable feature. The system may extract the sequentially aware feature (e.g., a sequence identifier) from the time-series data. This feature encapsulates the temporal dependencies and patterns within the sequence, such as the frequency of data processing requests, the duration between consecutive requests, or specific patterns indicating network congestion. The system defines a threshold or a set of conditions that will be used to convert the sequentially aware feature into a binary variable. The threshold is typically based on domain knowledge or statistical analysis of the feature's distribution. For instance, if the sequentially aware feature represents the number of data processing requests per minute, a threshold might be set at a certain number of requests that indicates an unusually high or low load on the network. Once the threshold is established, the system applies it to the sequentially aware feature to generate the binary variable feature. If the value of the sequentially aware feature exceeds the threshold, the binary variable is set to 1, indicating the presence of the condition of interest (e.g., high network load). If the value is below the threshold, the binary variable is set to 0, indicating the absence of that condition.

In some embodiments, converting the first sequential aware feature into the binary variable feature may comprise the system retrieving an attention matrix for the first artificial intelligence model, retrieving a sparsity parameter, and filtering attention values in the attention matrix based on the sparsity parameter. The attention matrix contains attention values that represent the weight or importance assigned to each element in the sequence relative to others. These values indicate how much focus the model places on each element when making predictions. The system retrieves a sparsity parameter, which is a predefined threshold that dictates the level of attention required for an element to be considered significant. The sparsity parameter is important for filtering the attention values, as it helps to distinguish between important and less important elements in the sequence. The system then applies the sparsity parameter to filter the attention values in the attention matrix. This involves comparing each attention value against the sparsity parameter. If an attention value exceeds the sparsity threshold, the corresponding element is deemed significant, and the system sets the binary variable to 1 for that element. Conversely, if an attention value falls below the threshold, the element is considered insignificant, and the binary variable is set to 0. By performing this filtering process, the system effectively converts the sequentially aware feature, which contains nuanced information about the importance of each element in the sequence, into a binary variable feature. This binary feature simplifies the representation, indicating whether each element in the sequence meets the significance criteria defined by the sparsity parameter.

In some embodiments, the system may additionally or alternatively, convert the first sequential aware feature into the binary variable feature by retrieving an attention matrix for the first artificial intelligence model, retrieving a threshold frequency parameter, wherein the threshold frequency parameter indicates a minimum frequency of an order of values of attention values in the attention matrix, and filtering attention values in the attention matrix based on the threshold frequency parameter. For example, the system may retrieve a threshold frequency parameter. This parameter represents a minimum frequency of occurrence for a particular order or pattern of attention values within the attention matrix. Essentially, it sets a benchmark for how often certain attention values or patterns need to appear to be considered significant. The system then analyzes the attention values in the attention matrix to identify patterns or orders of values that meet or exceed the threshold frequency parameter. This involves counting the occurrences of specific attention values or sequences and comparing these counts to the threshold frequency. If a particular pattern or set of attention values appears frequently enough, as determined by the threshold frequency parameter, it indicates that these values are significant. After identifying the significant attention values based on their frequency, the system proceeds to filter these values. For each element in the sequence, the system checks whether the corresponding attention value meets the criteria established by the threshold frequency parameter. If an attention value or pattern meets the threshold, the system sets the corresponding binary variable to 1, indicating that the element is significant. If the attention value does not meet the threshold, the binary variable is set to 0, indicating that the element is not significant. By filtering the attention values based on the threshold frequency parameter, the system effectively converts the sequentially aware feature into a binary variable feature. This binary feature simplifies the data representation by clearly distinguishing between significant and insignificant elements in the sequence. This approach ensures that the most relevant and frequently occurring patterns within the attention matrix are captured in the binary variable, providing a robust and interpretable representation of the sequential data for further analysis or decision-making processes.

The system may fit a decision tree to the binary variable feature. The system may collect and prepare the dataset that includes the binary variable feature as the target variable, along with other relevant input features that will be used for making predictions. These input features could include numerical, categorical, or even previously transformed sequentially aware features. The dataset is typically split into a training set and a test set to allow for model validation. The system initializes a decision tree classifier, specifying parameters such as the maximum depth of the tree, the minimum number of samples required to split an internal node, and the criterion for measuring the quality of a split (e.g., Gini impurity or entropy). These parameters help control the complexity of the tree and prevent overfitting. During the training phase, the system uses the training data to build the decision tree. The decision tree algorithm starts at the root node and recursively splits the dataset into subsets based on the values of the input features. At each node, the algorithm selects the feature and threshold that result in the best split, which is determined by maximizing the reduction in impurity (e.g., minimizing Gini impurity or maximizing information gain). This process continues until the stopping criteria are met, such as reaching the maximum tree depth or having too few samples to split further. As the tree is built, each internal node represents a decision point based on an input feature, and each branch represents the possible outcomes of that decision. Leaf nodes at the end of the branches represent the final prediction, which in this case is the binary variable feature (either 0 or 1). Once the decision tree is trained, the system evaluates its performance using the test set. It measures metrics such as accuracy, precision, recall, and the area under the ROC curve (AUC-ROC) to assess how well the tree can predict the binary variable feature on unseen data. If necessary, the system may tune the tree's parameters and retrain it to improve performance. The fitted decision tree model can then be used to make predictions on new data. The model analyzes the input features, follows the decision paths in the tree, and outputs the predicted binary variable, providing a clear and interpretable method for understanding how the input features influence the binary outcome.

In some embodiments, converting the first sequential aware feature into the binary variable feature may comprise the system determining a sequence identifier based on the first sequential aware feature and determining the binary variable feature based on the sequence identifier. The sequence identifier may be a unique marker or tag that represents specific patterns or characteristics identified within the sequence. For example, in a time-series dataset, the sequence identifier could be derived from detecting recurring patterns, significant changes, or specific events within the data. This identifier essentially captures the essence or a notable aspect of the sequence that is relevant for further analysis. Once the sequence identifier is established, the system uses it to determine the binary variable feature. The binary variable feature is created by mapping the sequence identifier to a binary value (0 or 1) based on predefined criteria or thresholds. For instance, if the sequence identifier indicates a pattern associated with a high level of activity or a critical event, the system might assign a binary value of 1. Conversely, if the sequence identifier corresponds to a pattern indicating normal or low activity, the binary value would be 0. To illustrate, consider a scenario where the sequentially aware feature tracks user engagement over time. The system might identify a sequence pattern indicating a drop in engagement (sequence identifier). Based on this identifier, if the drop surpasses a certain threshold, the binary variable feature is set to 1, signaling a significant change. If the engagement levels remain stable or show minor fluctuations, the binary variable feature is set to 0. By converting the sequentially aware feature into a binary variable feature through the use of sequence identifiers, the system simplifies the representation of complex temporal patterns. This binary feature can then be easily integrated into further analytical processes or machine learning models, providing a clear and actionable insight into the significant events or patterns identified within the sequential data.

At step 406, process 400 (e.g., using one or more components described above) receives a first output from the decision tree. For example, the system may receive a first output from the decision tree. The output from a decision tree is the final prediction or classification result that is derived from the tree's decision-making process. When a decision tree model is applied to a new data instance, it traverses the tree from the root node to a leaf node based on the values of the input features. Each internal node in the tree represents a decision point where the data is split according to a specific feature and threshold. The branches leading from each node correspond to the possible outcomes of that decision, guiding the traversal to the next node. As the data instance moves down the tree, it follows a path determined by successive feature-based splits until it reaches a leaf node. The leaf node represents the output of the decision tree for that particular instance. In the case of a classification task, the output is the predicted class label, such as 0 or 1 for a binary classification problem, or one of multiple class labels for a multi-class classification problem. The class label at the leaf node is typically determined by the majority class of the training samples that reached that node during the training process. For regression tasks, where the goal is to predict a continuous value, the output at the leaf node is a numerical value, usually the mean or median of the target values of the training samples that reached that node. This predicted value serves as the final output of the decision tree for the given input instance. The output from a decision tree is a clear and interpretable result, providing either a class label or a continuous value, depending on the nature of the task. This output is derived through a series of logical decisions based on the input features, making the decision tree a powerful tool for both classification and regression tasks.

In some embodiments, the system may fit the decision tree to the binary variable feature by retrieving a binary value from the binary variable feature and modifying a node of the decision tree based on the binary value. The system collects the dataset that includes the binary variable feature as the target variable, along with other relevant input features that will be used for making predictions. Each instance in the dataset consists of a set of input features and the corresponding binary value (0 or 1) from the binary variable feature. The system initializes the decision tree model, setting parameters such as the maximum depth of the tree, the minimum number of samples required to split an internal node, and the criterion for measuring the quality of a split (e.g., Gini impurity or entropy). During the training phase, the system iteratively builds the decision tree by processing the dataset. For each node in the tree, the system retrieves binary values from the binary variable feature and evaluates potential splits based on the input features. At each node, the system calculates the best split by determining which feature and threshold result in the most significant reduction in impurity (for classification tasks) or variance (for regression tasks). When a binary value of 1 is retrieved from the binary variable feature, the system interprets this as a positive outcome or a significant event. It then modifies the node to reflect this outcome by choosing the split that best separates the instances with a binary value of 1 from those with a binary value of 0. This process involves evaluating different features and thresholds to find the optimal split that maximizes the purity of the resulting subsets. Conversely, when a binary value of 0 is retrieved, the system modifies the node to reflect a negative outcome or an insignificant event. The goal is to find a split that effectively distinguishes between instances with binary values of 0 and those with binary values of 1, ensuring that each resulting subset is as homogeneous as possible. This process of retrieving binary values and modifying nodes continues recursively, with the system building the tree from the root node down to the leaf nodes. Each internal node represents a decision point based on an input feature, and each leaf node represents the final prediction, which is the binary value.

At step 408, process 400 (e.g., using one or more components described above) generates a first recommendation based on the first output. For example, the system may generate for display, on a user interface, a first recommendation based on the first output, wherein the first recommendation indicates an interaction outcome of the user and the first computer terminal. The system processes the user's input data, which could include interaction history, preferences, and other relevant features. This data is fed into the trained decision tree model, which traverses its nodes based on the input features until it reaches a leaf node, producing an output prediction. This output could be a classification label or a regression value that represents the predicted outcome of the user's interaction with the first computer terminal. Once the decision tree generates the output, the system interprets this result to formulate a recommendation. For instance, if the output indicates a high likelihood of user satisfaction based on previous interactions, the recommendation might be to continue offering similar services or products. Conversely, if the prediction suggests a potential issue or dissatisfaction, the recommendation might involve proactive steps to address the user's concerns, such as offering support or alternative solutions.

The system may then convert this recommendation into a format suitable for display on the user interface. This involves creating a clear and concise message that conveys the recommendation in an understandable manner. For example, the interface might display a message like, “Based on your recent activities, we recommend exploring these new features” or “We noticed you might be experiencing issues. Would you like to contact support?” The system renders this recommendation on the user interface, ensuring it is prominently displayed where the user can easily see and interact with it. The recommendation may be accompanied by interactive elements such as buttons or links, allowing the user to take immediate action based on the suggestion. By presenting the recommendation in a user-friendly and actionable format, the system enhances the user experience, guiding them toward positive interaction outcomes with the computer terminal.

In some embodiments, the system may generate for display, on a user interface, a first recommendation based on the first output by retrieving a plurality of recommendations and selecting the first recommendation from the plurality of recommendations based on the first output. The system may collect a diverse set of potential recommendations stored in a recommendation database or repository. Each recommendation in this repository is associated with specific criteria or conditions that dictate when it should be presented to a user. Once the system has generated an output, such as a prediction or classification result from a decision tree or another model, it uses this output to filter and evaluate the set of available recommendations. The system compares the output against the criteria associated with each recommendation. This involves checking if the conditions or thresholds defined for each recommendation are met by the output. For example, if the output indicates a high likelihood of user satisfaction with a certain feature, the system might look for recommendations that are tailored to enhancing user experience or promoting additional features. Conversely, if the output suggests potential dissatisfaction or a specific issue, the system will prioritize recommendations that address these concerns, such as offering support or alternative solutions. After evaluating the recommendations, the system selects the one that best aligns with the output. This selection process ensures that the chosen recommendation is the most relevant and beneficial for the user's current situation. The system then generates the selected recommendation in a format suitable for display on the user interface, crafting a clear and actionable message that the user can easily understand and interact with. Finally, the system displays the selected recommendation on the user interface, ensuring it is prominently positioned and user-friendly. Interactive elements, such as buttons or links, may be included to facilitate immediate user action based on the recommendation.

In some embodiments, the system may generate for display, on a user interface, a first recommendation based on the first output by retrieving a large language model and inputting the first output into the large language model. The process begins by retrieving the pre-trained large language model, which has been trained on extensive datasets to understand and generate human-like text. Once the model is loaded, the system inputs the first output into the LLM. This first output, which could be a prediction, classification result, or any other analytical output from a preceding process, serves as the prompt or context for generating a recommendation. The large language model processes the input, leveraging its deep understanding of language patterns and context to formulate a relevant and coherent recommendation. The LLM uses its embedded knowledge and the context provided by the first output to generate a recommendation that aligns with the user's needs or the system's goals. For instance, if the first output indicates a user's preference or a detected issue, the LLM can craft a recommendation that either enhances the user's experience or addresses the problem effectively. Once the LLM generates the recommendation, the system formats this recommendation into a user-friendly message suitable for display. This involves ensuring the recommendation is clear, concise, and actionable, allowing the user to understand and act upon it easily. The formatted recommendation is then displayed on the user interface, often accompanied by interactive elements such as buttons or links that facilitate further actions. By using a large language model to generate recommendations based on the first output, the system can provide highly contextualized and nuanced suggestions that improve user engagement and satisfaction.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for using decision trees for artificial intelligence models operating on non-tabular or sequential data that require interpretability.
2. The method of the preceding embodiment, further comprising: receiving user profile data of a user interacting with a first computer terminal; inputting the user profile data into a decision tree, wherein the decision tree is generated by: retrieving a first artificial intelligence model, wherein the first artificial intelligence model is a transformer model for determining recommendations, wherein the transformer model is trained on a first training data set to generate sequential aware features, and wherein the first training data set comprises sequential time-series data that is generated based on monitoring data processing requests across a plurality of computer networks; determining a first sequential aware feature for the first artificial intelligence model; converting the first sequential aware feature into a binary variable feature; and fitting a decision tree to the binary variable feature; receiving a first output from the decision tree; and generating for display, on a user interface, a first recommendation based on the first output, wherein the first recommendation indicates an interaction outcome of the user and the first computer terminal.
3. The method of any one of the preceding embodiments, wherein determining the first sequential aware feature for the first artificial intelligence model comprises: determining an attention value for first artificial intelligence model; and populating an attention matrix for the first artificial intelligence model with the attention value.
4. The method of any one of the preceding embodiments, wherein converting the first sequential aware feature into the binary variable feature comprises: retrieving an attention matrix for the first artificial intelligence model; retrieving a sparsity parameter; and filtering attention values in the attention matrix based on the sparsity parameter.
5. The method of any one of the preceding embodiments, wherein converting the first sequential aware feature into the binary variable feature comprises: retrieving an attention matrix for the first artificial intelligence model; retrieving a threshold frequency parameter, wherein the threshold frequency parameter indicates a minimum frequency of an order of values of attention values in the attention matrix; and filtering attention values in the attention matrix based on the threshold frequency parameter.
6. The method of any one of the preceding embodiments, wherein converting the first sequential aware feature into the binary variable feature comprises: retrieving an attention matrix for the first artificial intelligence model; retrieving a sparsity parameter; filtering attention values in the attention matrix based on the sparsity parameter to generate a sparsity-based attention matrix; retrieving a threshold frequency parameter, wherein the threshold frequency parameter indicates a minimum frequency of an order of values of attention values in the attention matrix; and filtering the sparsity-based attention matrix based on the threshold frequency parameter.
7. The method of any one of the preceding embodiments, wherein converting the first sequential aware feature into the binary variable feature comprises: retrieving an attention matrix filtered by a threshold frequency parameter, wherein the threshold frequency parameter indicates a minimum frequency of an order of values of attention values in the attention matrix; and generating the binary variable feature based on the attention matrix.
8. The method of any one of the preceding embodiments, wherein generating the binary variable feature based on the attention matrix further comprises: retrieving an attention value from the attention matrix; and determining a binary value corresponding to the attention value.
9. The method of any one of the preceding embodiments, wherein fitting the decision tree to the binary variable feature further comprises: retrieving a binary value from the binary variable feature; and modifying a node of the decision tree based on the binary value.
10. The method of any one of the preceding embodiments, wherein generating for display, on a user interface, a first recommendation based on the first output further comprising: retrieving a plurality of recommendations; and selecting the first recommendation from the plurality of recommendations based on the first output.
11. The method of any one of the preceding embodiments, wherein generating for display, on a user interface, a first recommendation based on the first output further comprising: retrieving a large language model; and inputting the first output into the large language model.
12. The method of any one of the preceding embodiments, wherein generating for display, on a user interface, a first recommendation based on the first output further comprising: generating a first embedding based on the first output; and determining the first recommendation based on the first embedding.
13. The method of any one of the preceding embodiments, wherein converting the first sequential aware feature into the binary variable feature further comprises: determining a sequence identifier based on the first sequential aware feature; and determining the binary variable feature based on the sequence identifier.
14. The method of any one of the preceding embodiments, wherein receiving the first output from the decision tree further comprises: processing the user profile data using the decision tree; and determining a value in the user profile data having a predetermined attention value and a predetermined sequence identifier.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for determining interpretable network routing decisions using decision trees for artificial intelligence models operating on non-tabular or sequential network data, the system comprising:
receiving a request for a network route across a first computer network for a first data processing request;
determining current network profile data for the first computer network;
inputting the network profile data into a decision tree, wherein the decision tree is generated by:
retrieving a first artificial intelligence model, wherein the first artificial intelligence model is a transformer model for determining network routes, wherein the transformer model is trained on a first training data set to generate sequential aware features, and wherein the first training data set comprises sequential time-series data that is generated based on monitoring data processing requests across a plurality of computer networks;
determining a first sequential aware feature for the first artificial intelligence model;
converting the first sequential aware feature into a binary variable feature; and
fitting a decision tree to the binary variable feature;
receiving a first output from the decision tree; and
generating for display, on a user interface, a first recommended network route for the first data processing request based on the first output.

2. A method for using decision trees for artificial intelligence models operating on non-tabular or sequential data that require interpretability, the method comprising:
receiving user profile data of a user interacting with a first computer terminal;
inputting the user profile data into a decision tree, wherein the decision tree is generated by:
retrieving a first artificial intelligence model, wherein the first artificial intelligence model is a transformer model for determining recommendations, wherein the transformer model is trained on a first training data set to generate sequential aware features, and wherein the first training data set comprises sequential time-series data that is generated based on monitoring data processing requests across a plurality of computer networks;
determining a first sequential aware feature for the first artificial intelligence model;
converting the first sequential aware feature into a binary variable feature; and
fitting a decision tree to the binary variable feature;
receiving a first output from the decision tree; and
generating for display, on a user interface, a first recommendation based on the first output, wherein the first recommendation indicates an interaction outcome of the user and the first computer terminal.

3. The method of claim 2, wherein determining the first sequential aware feature for the first artificial intelligence model comprises:
determining an attention value for first artificial intelligence model; and
populating an attention matrix for the first artificial intelligence model with the attention value.

4. The method of claim 2, wherein converting the first sequential aware feature into the binary variable feature comprises:
retrieving an attention matrix for the first artificial intelligence model;
retrieving a sparsity parameter; and
filtering attention values in the attention matrix based on the sparsity parameter.

5. The method of claim 2, wherein converting the first sequential aware feature into the binary variable feature comprises:
retrieving an attention matrix for the first artificial intelligence model;
retrieving a threshold frequency parameter, wherein the threshold frequency parameter indicates a minimum frequency of an order of values of attention values in the attention matrix; and
filtering attention values in the attention matrix based on the threshold frequency parameter.

6. The method of claim 2, wherein converting the first sequential aware feature into the binary variable feature comprises:
retrieving an attention matrix for the first artificial intelligence model;
retrieving a sparsity parameter;
filtering attention values in the attention matrix based on the sparsity parameter to generate a sparsity-based attention matrix;
retrieving a threshold frequency parameter, wherein the threshold frequency parameter indicates a minimum frequency of an order of values of attention values in the attention matrix; and
filtering the sparsity-based attention matrix based on the threshold frequency parameter.

7. The method of claim 2, wherein converting the first sequential aware feature into the binary variable feature comprises:
retrieving an attention matrix filtered by a threshold frequency parameter, wherein the threshold frequency parameter indicates a minimum frequency of an order of values of attention values in the attention matrix; and
generating the binary variable feature based on the attention matrix.

8. The method of claim 7, wherein generating the binary variable feature based on the attention matrix further comprises:
retrieving an attention value from the attention matrix; and
determining a binary value corresponding to the attention value.

9. The method of claim 2, wherein fitting the decision tree to the binary variable feature further comprises:
retrieving a binary value from the binary variable feature; and
modifying a node of the decision tree based on the binary value.

10. The method of claim 2, wherein generating for display, on a user interface, a first recommendation based on the first output further comprising:
retrieving a plurality of recommendations; and
selecting the first recommendation from the plurality of recommendations based on the first output.

11. The method of claim 2, wherein generating for display, on a user interface, a first recommendation based on the first output further comprising:
retrieving a large language model; and
inputting the first output into the large language model.

12. The method of claim 2, wherein generating for display, on a user interface, a first recommendation based on the first output further comprising:
generating a first embedding based on the first output; and
determining the first recommendation based on the first embedding.

13. The method of claim 2, wherein converting the first sequential aware feature into the binary variable feature further comprises:
determining a sequence identifier based on the first sequential aware feature; and
determining the binary variable feature based on the sequence identifier.

14. The method of claim 2, wherein receiving the first output from the decision tree further comprises:
processing the user profile data using the decision tree; and
determining a value in the user profile data having a predetermined attention value and a predetermined sequence identifier.

15. One or more non-transitory, computer-readable media, comprising instructions that, when executed by one or more processors, cause operations comprising:
inputting user profile data into a decision tree, wherein the decision tree is generated by:
retrieving a first artificial intelligence model, wherein the first artificial intelligence model is a transformer model for determining recommendations, wherein the transformer model is trained on a first training data set to generate sequential aware features, and wherein the first training data set comprises sequential time-series data that is generated based on monitoring data processing requests across a plurality of computer networks;
determining a first sequential aware feature for the first artificial intelligence model;
converting the first sequential aware feature into a binary variable feature; and
fitting a decision tree to the binary variable feature; and
receiving a first output from the decision tree.

16. The one or more non-transitory, computer-readable media of claim 15, wherein determining the first sequential aware feature for the first artificial intelligence model comprises:
determining an attention value for first artificial intelligence model; and
populating an attention matrix for the first artificial intelligence model with the attention value.

17. The one or more non-transitory, computer-readable media of claim 15, wherein converting the first sequential aware feature into the binary variable feature comprises:
retrieving an attention matrix for the first artificial intelligence model;
retrieving a sparsity parameter; and
filtering attention values in the attention matrix based on the sparsity parameter.

18. The one or more non-transitory, computer-readable media of claim 15, wherein converting the first sequential aware feature into the binary variable feature comprises:
retrieving an attention matrix for the first artificial intelligence model;
retrieving a threshold frequency parameter, wherein the threshold frequency parameter indicates a minimum frequency of an order of values of attention values in the attention matrix; and
filtering attention values in the attention matrix based on the threshold frequency parameter.

19. The one or more non-transitory, computer-readable media of claim 15, wherein converting the first sequential aware feature into the binary variable feature comprises:
retrieving an attention matrix for the first artificial intelligence model;
retrieving a sparsity parameter;
filtering attention values in the attention matrix based on the sparsity parameter to generate a sparsity-based attention matrix;
retrieving a threshold frequency parameter, wherein the threshold frequency parameter indicates a minimum frequency of an order of values of attention values in the attention matrix; and
filtering the sparsity-based attention matrix based on the threshold frequency parameter.

20. The one or more non-transitory, computer-readable media of claim 15, wherein converting the first sequential aware feature into the binary variable feature comprises:
retrieving an attention matrix filtered by a threshold frequency parameter, wherein the threshold frequency parameter indicates a minimum frequency of an order of values of attention values in the attention matrix; and
generating the binary variable feature based on the attention matrix.
